(19) United States
(12) Patent Application Publication
(10) Pub. No.: US 2011/0063682 A1
(43) Pub. Date: Mar. 17, 2011

(54) PRINT APPARATUS, PRINT CONTROL APPARATUS AND IMAGE PROCESSING APPARATUS

(75) Inventor: Yoshiji Kanamoto, Tokyo (JP)

(73) Assignee: CANON KABUSHIKI KAISHA, Tokyo (JP)

(21) Appl. No.: 12/869,685

(22) Filed: Aug. 26, 2010

(30) Foreign Application Priority Data
Sep. 17, 2009 (JP) 2009-216167

(51) Int. Cl. G06K 15/00

(52) U.S. Cl. 358/1.18

(57) ABSTRACT

When a combining instruction for combining first image data with second image data being stored in a print apparatus is accepted, a processing parameter that has been set for the second image data to be combined with the first image data is obtained, and a determination is made of whether or not an image area of the first image data and an image area of the second image data match if the first image data and the second image data are overlaid, based on the processing parameter, and when determined that the image area of the first image data and the image area of the second image data do not match, the first image data is modified, and that modified first image data is transmitted to the print apparatus.

### BACKGROUND OF THE INVENTION

1. Field of the Invention

The present invention relates to a print apparatus and a print control apparatus that receive and print a print job from an external device, and an image processing apparatus.

2. Description of the Related Art

The market is expanding for Print On Demand (POD), in which a digital printing device is used instead of a conventional offset printing device widely used in commercial printing. In view of such circumstances, manufacturers of office equipment and the like are investigating new entry into the POD market, which is a new field. In particular, recently, for example, there has been ongoing investigation of print apparatuses and printing systems adapted to not only an office environment, but also to a POD environment where different use cases and needs than for an office environment are assumed. For example, a printing system is sought that utilizes a benefit that it is possible to produce only a necessary amount of high-grade printed matter having high image quality without creating an offset plate, and so printing is profitable even when printing in small lots, unlike an offset printing device often used in commercial printing.

Also, the benefit of being able to produce printed matter without creating an offset plate is not limited to the above; for example, a system as described below can be realized by on-demand printing using a digital printing device.

In a digital printing device, by compositing image data that has been separately created not when creating the data with an application, but when printing, it is possible to produce more complicated printed matter of high quality and high added value. Examples of this function include clear color composition, specific color composition, form composition, and so forth. The clear color composition indicates composition of image data to be printed using transparent toner with image data to be printed using CMYK toner. By thus performing printing by compositing image data that has been separately created at the time of printing, data or the like that cannot be expressed or is very difficult to express with a single prepress application (or system) can be more easily produced. Specifically, it is possible to produce clear composition output matter using an existing application, even if there is not a special application capable of editing a clear offset plate in addition to an ordinary offset plate. Specifically, utilizing the composition function of a digital printing device capable of compositing a plurality of items of image data, it is possible to avoid a problem that occurs when realizing offset plate composition due to transporting paper a plurality of times, which is frequently performed at the time of printing (see Japanese Patent Laid-Open No. 9-247425). In other words, it is possible to reliably obtain high grade printed matter, without inviting complication of operator procedures, or a decrease in print quality due to fan-out or misregistration. Misregistration is a phenomenon wherein the quality of an image obtained by compositing and then printed decreases due to the position of the composited image being offset by a predetermined amount.

As described above, by using a POD-compatible digital printing device, it is possible to obtain high grade printed matter by a simpler method. However, in reality, there are problems with respect to the convenience of the above approach. In the above case, the image data to be composited and the image data to undergo composition are separately created, and image composition is performed using the image composition function of the digital printing device. That is, as described above, although the complication of work and composition processing instructions accompanying the creation of each offset plate is greatly reduced, because the image data to be composited and the image data to undergo composition are created in separate processes, positioning of image objects included in the respective image data is difficult. When image objects have not been accurately positioned, the phenomenon of misregistration appears, and so the grade of printed matter is markedly reduced.

Causes of such problems include the following, for example. First, there may be minute differences in the arrangement of image objects due to using different applications when creating the respective items of image data. Second, the above problems may be caused by differences in a driver/RIP used when performing 1-bit TIFF (or bitmap) conversion processing of original image data. Third, the above problems may be caused by differences in the origin coordinates or default scaling (or adjusted value for scaling) of the driver/RIP processing system. Fourth, the above problems may be caused by differences in default values (such as scaling, margins, origin position, origin coordinates, or surface contents box size) for each of other applications.

In order to avoid such problems, at the stage when the operator creates the image data to be composited and the image data to undergo composition, in consideration of processes prior thereto, it is necessary to perform work with great care so as to not allow the above causes of misregistration to occur. Because there is a wide variety of settings items and specifications that the operator must pay attention to at the time of creation, such as detailed specifications per pixel for each application and each driver, application default values, and so forth, operation is complicated and so there is a large burden on the operator.

### SUMMARY OF THE INVENTION

An aspect of the present invention is to eliminate the above-mentioned problems with the conventional technology.

In one aspect of the present invention, misregistration when printing a composite image is prevented while also suppressing the occurrence of a large burden on an operator.

According to an aspect of the present invention, there is provided a print apparatus for receiving image data from an external device and executing printing based on the received image data, the apparatus comprising: a receiving unit that receives first image data; a storage unit that stores second image data to be combined with the first image data received by the receiving unit; a determination unit that determines whether or not an image area of the first image data and an image area of the second image data match if the second image data of the storage unit is overlaid with the first image data; a modification unit that modifies any one of the first image data and the second image data when the determination unit determines that the image area of the first image data and the image area of the second image data do not match; and a print unit that performs printing by overlaying the one of the first image data and the second image data that has been modified by the modification unit with the other image data that has not been modified by the modification unit.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts a view illustrating a configuration of a printing (POD) system according to an embodiment of the present invention.

FIG. 2 is a block diagram describing the configuration of a digital printing device.

FIG. 3 is a block diagram describing the configuration of a computer according to an embodiment.

FIG. 4 depicts an external view of a console unit of the printing device according to the present embodiment.

FIG. 5 depicts a view describing an example of various programs and data stored in a ROM of the printing device.

FIG. 6 depicts a view describing an example of the configuration of various information stored in an HDD of the digital printing device.

FIG. 7 depicts a view describing an example of a document management table.

FIG. 8 depicts a view illustrating an example of document data (an image) that has been created by the computer.

FIG. 9 depicts a view illustrating an example of a job ticket issued from the computer.

FIG. 10 depicts a view describing an example data configuration of a print job received by the digital printing device.

FIG. 11 depicts a view illustrating an example of a result of the digital printing device receiving a job ticket and performing conversion processing.

FIG. 12 depicts a view illustrating an example of second document data (an image) that has been created by the computer.

FIG. 13 depicts a view illustrating an example of a UI screen displayed in a display unit by a printer driver of the computer.

FIG. 14 depicts a view illustrating an example of a UI screen when a page option has been instructed.

FIG. 15 depicts a view illustrating a UI screen displayed when an “OK” button has been instructed in FIG. 14.

FIG. 16 is a flowchart describing print processing executed by the computer according to the present embodiment.

FIG. 17 is a flowchart describing processing related to information obtaining processing of document data to be composited when performing processing for a setting of clear composition printing in step S1 of FIG. 16.

FIG. 18 is a flowchart describing computer processing executed when the “OK” button in FIG. 14 has been instructed in a state in which a radio button in FIG. 14 has been selected.

FIG. 19 is a flowchart describing print processing executed when the digital printing device according to the present embodiment has received a print job from the computer.

FIG. 20 is a flowchart describing details of image processing executed in step S34 of FIG. 19.

FIG. 21 is a flowchart describing print processing executed in step S39 of FIG. 19.

FIG. 22 is a flowchart describing processing that accompanies modification of scaling of an image to be composited in step S34 of FIG. 19.

FIG. 23 depicts a view illustrating an example of a screen according to another embodiment that corresponds to FIG. 14.

FIG. 24 depicts a view illustrating an example of a screen displayed immediately after identifying that the scaling of an image to be composited and the scaling of an image to undergo composition are not the same, when clear image data to be composited has been selected.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

### First Embodiment

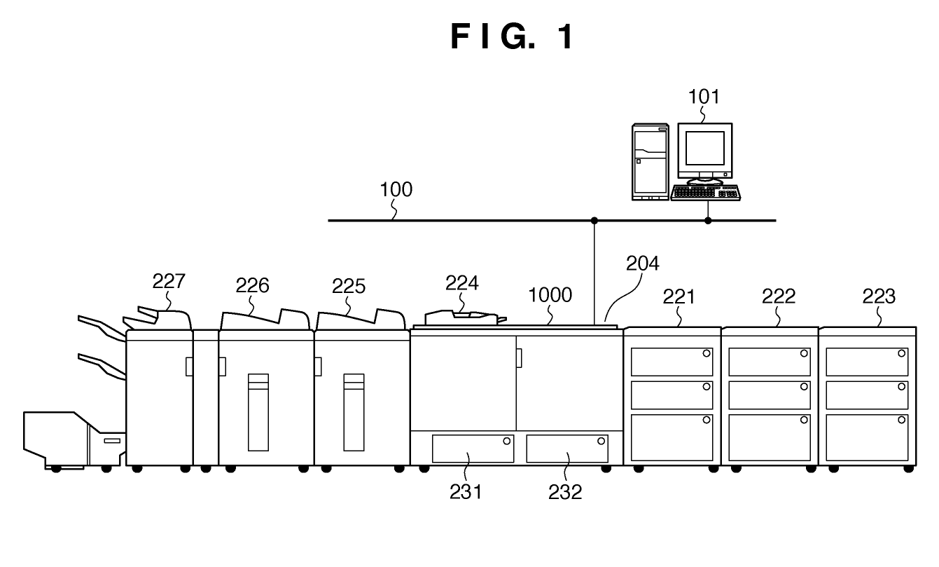

FIG. 1 depicts a view illustrating the configuration of a printing (POD) system according to an embodiment of the present invention. In this system, apparatuses having a plurality of different roles are connected to each other, and thus it is possible to perform complicated sheet processing (such as bookbinding, folding, or punching) on paper that has been printed.

A digital printing device 1000 prints images using a recording agent such as a toner on media (a sheet) based on image data. Below is a simple description of print processing when the digital printing device 1000 is a print apparatus employing an electrophotographic method. A semiconductor laser is driven by a signal modulated according to image data to emit laser light, and this laser light is reflected by a multi-sided mirror (such as a polygonal mirror) and irradiated onto a uniformly charged photosensitive drum. Thus, a latent image corresponding to the image data is formed on the photosensitive drum, and this latent image is developed using toner. A toner image thus developed on the photosensitive drum is transferred to a sheet that has been applied to a transfer drum. By sequentially executing this series of processes for toner of respective colors yellow (Y), magenta (M), cyan (C), and black (K), a full-color image is formed on the sheet. Also, a configuration may be adopted in which in addition to those four colors, it is possible to transfer toner referred to as a specific color, transparent toner, or the like. The digital printing device 1000 according to the present embodiment is furthermore configured to be capable of transferring transparent toner. A sheet on which a full-color image has been formed in this way is transported to a fixing unit. The fixing unit has rollers and belts, and includes a heat source such as a halogen heater, and with heat and pressure, melts the toner of the sheet to which the toner image has been transferred, thus fixing the image on the sheet.

The digital printing device 1000 according to the present embodiment is provided with a scanner 224 and a console unit 204. The console unit 204 provides various interfaces when an operator performs various settings, operations, or the like of the digital printing device 1000 according to the present embodiment. This digital printing device 1000 is configured such that various ancillary apparatuses can also be attached.

Large-volume paper feeding units 221, 222, and 223 are paper feeding units that are detachable from the digital printing device 1000, and supply sheets to a print unit of the digital printing device 1000. As shown in FIG. 1, it is possible to attach a plurality of paper feeding units to the digital printing device 1000. Thus, it is possible to execute print processing on a large volume of sheets.

Large-volume stackers 225 and 226 are apparatuses for internally stocking a large volume of printed sheets that have been output. In a system provided with a large-volume paper feeding unit, a large volume of printed matter (sheets) is produced, so such a large-volume stacker is necessary. In the system configuration shown in FIG. 1, two large-volume stackers are connected.

A saddle stitching apparatus 227 is provided with various units capable of selectively executing a stapling process, a cutting process, a punching process, a folding process, a shifted paper discharge process, and so forth on printed sheets.

This POD system can be understood as largely divided into three parts, centered around the digital printing device 1000. Apparatuses located to the right side of the digital printing device 1000 in FIG. 1 are referred to as paper feeding system units. The main role of the paper feeding system units is to continuously, and at an appropriate timing, supply internally loaded sheets to the digital printing device 1000. The paper feeding system units also perform detection or the like of the remaining amount of internally loaded sheets. There also are paper feed cassettes 231 and 232 within the digital printing device 1000, and the paper feed cassettes 231 and 232 are functionally the same as the paper feeding system units, supplying sheets to the print unit of the digital printing device 1000. In the present description, the paper feed cassettes 231 and 232 provided in the digital printing device 1000 are also referred to as paper feeding system units.

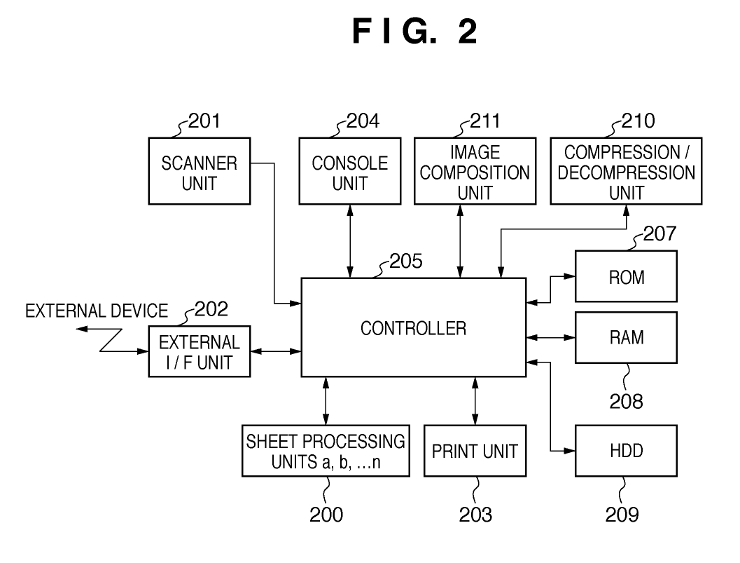

On the other hand, apparatuses located to the left side of the digital printing device 1000 in FIG. 1 are referred to as sheet processing units. The sheet processing units perform various processing on sheets for which print processing has completed, accumulation of such sheets, and so forth. The paper feeding system units and the sheet processing units are collectively referred to as sheet processing units (indicated by reference numeral 200 in FIG. 2) in the description below.

A computer 101 is a general-purpose computer (PC) that has been connected to the digital printing device 1000 via a network 100. With this computer 101, various application programs can be executed, and print jobs can be transmitted to the digital printing device 1000.

Next is a description of the configuration (mainly the software configuration) of the digital printing device 1000 according to the present embodiment.

FIG. 2 is a block diagram that shows the configuration of the digital printing device 1000, which serves as an example of a print apparatus.

A hard disk (below, HDD) 209 is a storage unit capable of storing document data, data of a job to be processed, and so forth. A job includes image data to be processed, and settings information for processing of the image data. Also, the digital printing device 1000 is provided with a copy function of inputting data from a scanner unit 201 of the digital printing device 1000, storing the data in the HDD 209, and printing the data with a print unit 203. Also, the digital printing device 1000 is provided with a print function or the like of storing in the HDD 209 job data that has been input from an external apparatus (for example, PC 101) via an external I/F unit 202 serving as a communications unit, and printing that job data with the print unit 203. The digital printing device 1000 is such a multi-function print apparatus (image forming apparatus) having a plurality of functions. This digital printing device 1000 may be for color printing or may be for monochrome printing.

The console unit 204 constitutes a user interface, and has a display unit for providing various displays to a user, and a touch panel and key input unit operated by the user to input various data.

A controller (or CPU) 205 performs central control of processing, operation, and so forth of the various units provided in the digital printing device 1000. In a ROM 207, various control programs are stored, including programs for executing various processing and so forth in flowcharts described below. Also stored in the ROM 207 is a display control program for allowing display of a user interface screen (below, UI screen) in a display unit of the console unit 204. By reading out and executing programs in the ROM 207, the controller 205 causes execution of various operations according to this embodiment. Also stored in the ROM 207 is, for example, a program that executes an operation to interpret PDL (Page Description Language) code data received from an external apparatus via the external I/F unit 202, and converts the data to raster image data (bitmap image data). A RAM 208 provides a work area when control processing is performed by the controller 205, and temporarily saves various data. The RAM 208 also stores image data that has been sent from the scanner unit 201 or the external I/F unit 202 via the controller 205, and various programs and settings information.

A compression/decompression unit (codec) 210 compresses/decompresses image data that is stored in the RAM 208 or the HDD 209 using various compression methods, such as JBIG or JPEG compression. An image composition unit 211, when a job has been transmitted to the digital printing device 1000 and in the settings for that job there has been an instruction to perform composition processing with image data that has been created in a separate job, produces a composite image based on the instruction. In the above sort of configuration, the controller 205 also controls operation of the respective sheet processing units 200. The sheet processing units 200 correspond to the paper feeding system units and the sheet processing units described with reference to FIG. 1.

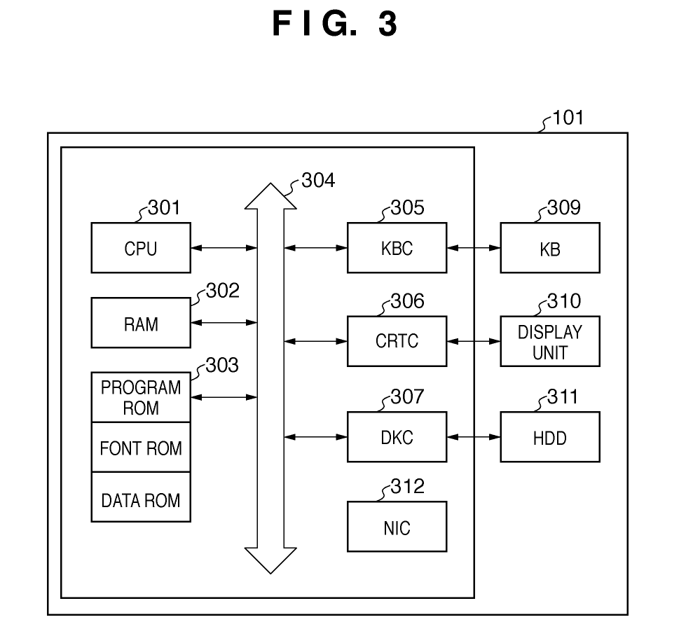

FIG. 3 is a block diagram describing the configuration of the computer (print control apparatus) 101 according to this embodiment.

A CPU 301 executes programs such as an OS, a general application, or a bookbinding application that have been stored in a program ROM of a ROM 303 or loaded from a hard disk 311 into a RAM 302. According to those programs, the CPU 301 executes control procedures indicated in flowcharts described below. The RAM 302 functions as a main memory, a work area, or the like of the CPU 301. A keyboard controller (KBC) 305 controls input from a keyboard 309 or an unshown pointing device. A display controller (CRTC) 306 controls display of a display unit 310. The display unit 310 also includes a display unit of liquid crystal or the like. A disk controller (DKC) 307 controls access to the hard disk (HDD) 311, a floppy (registered trademark) disk (FD), and so forth configured to store boot programs, various applications, font data, user files, files, and so forth. A NIC (network interface card) 312 is connected to the network 100, and executes processing to control exchange of signals with the digital printing device 1000 connected to the network 100, and processing to control communications with other devices. A system bus 304 is configured to connect the CPU 301 with the aforementioned controllers 305 to 307, RAM 302, ROM 303, NIC 312, and so forth.

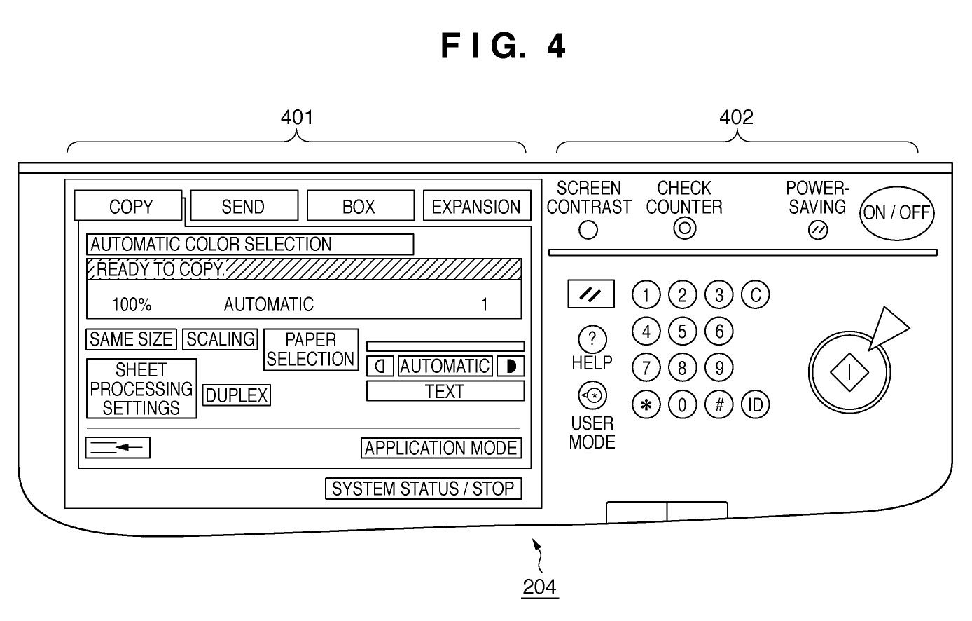

FIG. 4 depicts a view illustrating an example of the console unit 204 of the printing device 1000 according to the present embodiment.

The console unit 204 has a touch panel unit 401, which is a display unit capable of accepting user operation from software keys (display keys), and a key input unit 402 capable of accepting user operation from hardware keys. As for screens to be displayed on a display unit of the touch panel unit 401, an example screen among various display screens that are displayed by the controller 205 via the display unit is shown. The items displayed on the display unit, or the items that can be operated, change according to operation by the user or apparatus state.

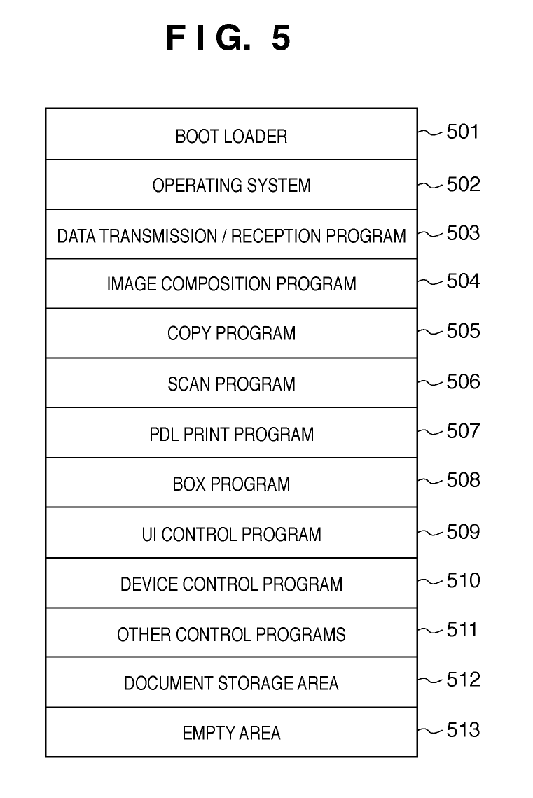

FIG. 5 depicts a view describing an example of various programs, and data used by these programs or the like, stored in the ROM 207 (FIG. 2) of the digital printing device 1000 according to this embodiment.

A boot loader 501 is a program to be executed immediately after powering on the digital printing device 1000. Included in this program is a program for executing various boot sequences necessary for booting the system. An operating system 502 is a program for supplying a run-time environment for various programs that realize functions of the digital printing device 1000. This environment mainly supplies functions such as a memory of the digital printing device 1000, the ROM 207 and the RAM 208, management of resources such as the hard disk 209, and basic input/output control of various apparatuses. A data transmission/reception program 503 performs transmission/reception processing performed when a data input/output request has occurred via the external I/F unit 202. Basically, this program performs communications, involving a protocol stack of networking protocols such as TCP/IP, of various data exchanged with an external device or the like capable of connection via the network 100. This communications processing is responsible for processing specialized for communications processing at the level of transmitting/receiving data packets that are input/output between the digital printing device 1000 and the external I/F unit 202, or communications processing for an HTTP server or the like, and does not include analysis processing related to the content of data that has been received, which will be described below. This analysis processing is executed according to a separate program by the controller 205, described below. An image composition program 504 forms a composite image by compositing image data that is held in the HDD 209 and image data included in a print job that has been received by the data transmission/reception program 503, based on instructions from the controller 205. A copy program 505 executes a copy function executed by the controller 205, according to instructions that are input with the console unit 204, when the user has used the console unit 204 to instruct execution of the copy function. With this copy function, resources of the digital printing device 1000 are controlled such that, based on the processing procedures and processing conditions described in that program, operation of the respective devices is sequentially instructed in an appropriate order, and ultimately copy processing is executed. Included among the aforementioned respective devices are the scanner unit 201, the print unit 203, the sheet processing units 200, the HDD 209, the compression/decompression unit 210, the RAM 208, and so forth.

A scan program 506, when the user instructs execution of a scan function from the console unit 204, causes execution of the scan function in the scanner unit 201 by the controller 205 due to that instruction. A PDL print program 507 causes execution of a PDL print function by the controller 205 when PDL job data is received via the external I/F unit 202. When the user instructs execution of a box function from the console unit 204, a box program 508 causes execution of the box function by the controller 205 due to the instruction. With this box function, image data that has been read by the scanner unit 201 or image data that has been input via the external I/F unit 202 is stored in a box area of the HDD 209, image data stored in the box area is read out, and so forth. A UI control program 509 is a program for controlling the touch panel unit 401 and the key input unit 402 of the console unit 204. The UI control program 509 discerns the content that has been input by the user using the console unit 204, and performs appropriate screen transitions and instruction to the controller 205. A device control program 510 controls the aforementioned respective devices. Other control programs 511 are programs for realizing functions that do not correspond to any of the above programs. Various programs are included among the control programs 511, but are not important for giving a description of the present embodiment, so a description of those various programs is omitted. Fixed document data such as messages is stored in a document storage area 512. Reference numeral 513 denotes an empty area.

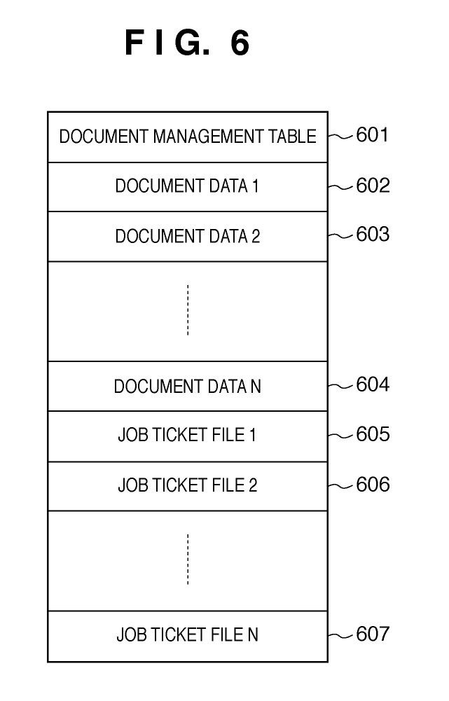

FIG. 6 depicts a view illustrating an example of the configuration of various information stored in the HDD 209 of the digital printing device 1000.

A document management table 601 is a table for managing document data that is held in the HDD 209 in association with job tickets that were used when creating the document data. Details of the information managed in this table will be described below. Items 602 to 604 of document data correspond to items of image data being held in the HDD 209. For example, such items 602 to 604 of document data may be document data obtained by the controller 205 converting a print job that has been delivered from the computer 101 to the printing device 1000 to bitmap data. They may also be bitmap data of an original that has been read by the scanner unit 201. These items of document data can be printed by the printing device 1000 with an instruction from the console unit 204. However, in the present embodiment, it is intended that such items of document data are used as an image to be composited in image composition processing described below, so in the present description they are referred to as data to be composited, unless specifically stated otherwise. Job ticket files 605 to 607 are obtained by converting job settings information used when creating the items 602 to 604 of document data into files.

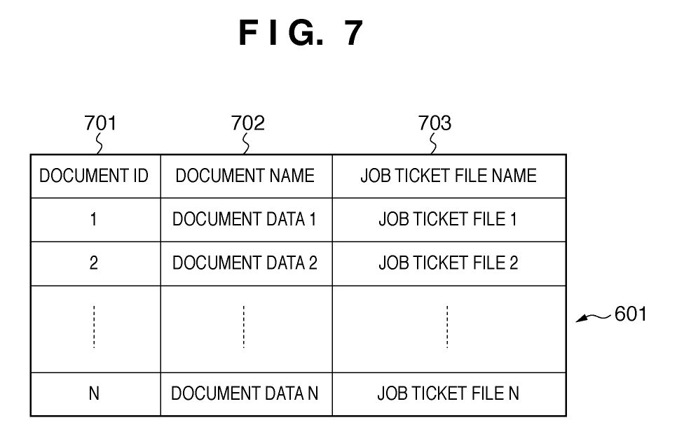

FIG. 7 depicts a view illustrating an example of the document management table 601.

Here, information recorded within a database is managed in record units. A document ID 701 corresponds to a database record ID. In the processing of the digital printing device 1000, when document data stored in the HDD 209 is designated and used for various control, reference is made to this document ID 701. A document name 702 corresponds to a file name of document data that is associated with the document ID 701. Although this file name is used to identify a file in the HDD 209, because the file name is used to allow the user to designate a specific document via the console unit 204, for example, the file name can also be used as information to be referred to when making a selection. Likewise, the computer 101 can obtain a document data list stored in the HDD 209 of the digital printing device 1000, and provide this document data list for various uses. When doing so, it is possible to use a document name of the document name 702 also as information to be displayed in the display unit 310 of the computer 101. A job ticket file name 703 indicates the file name used when a job ticket that was used when creating the document data contained in the document name 702 was saved in the form of a file. The name of the file name 703, like the document name 702, can be used as information to be displayed by the console unit 204 or the computer 101.

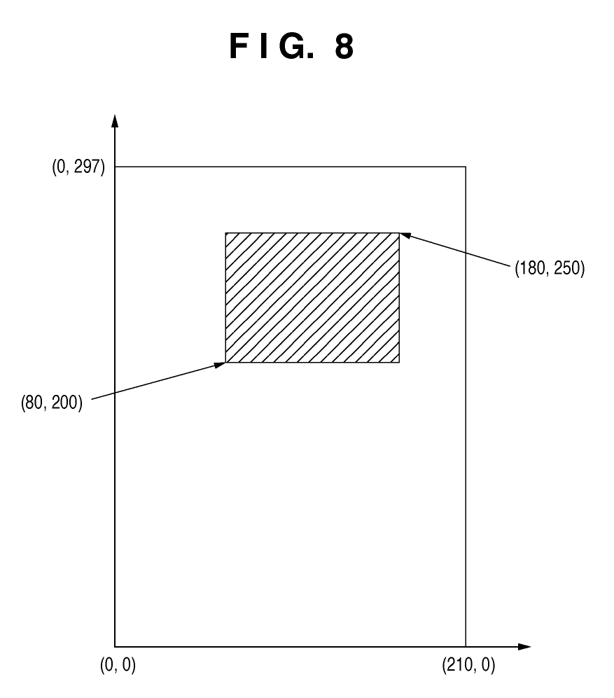

FIG. 8 depicts a view illustrating an example of document data (an image) that has been created by the computer 101 according to this embodiment.

This image has a length in the horizontal (X) direction of 210 mm, and has a length in the vertical (Y) direction of 297 mm. This image includes a rendered object displayed as a single rectangle, and the coordinates of the vertexes on a diagonal line of the rectangle are respectively (80, 200) and (180, 250). The density of pixels that constitute the image of this rectangular area, in order to simplify the description, is set to maximum density (for example, “255” in the case of 8-bit image data). The actual format of this image information is inherent to the application that was used to create the image. Accordingly, the format is discretionary.

Such image data is received from the computer 101 and saved in the HDD 209 without printing when “save” has been instructed rather than printing as the “output method” in a UI screen of the print driver of the computer 101.

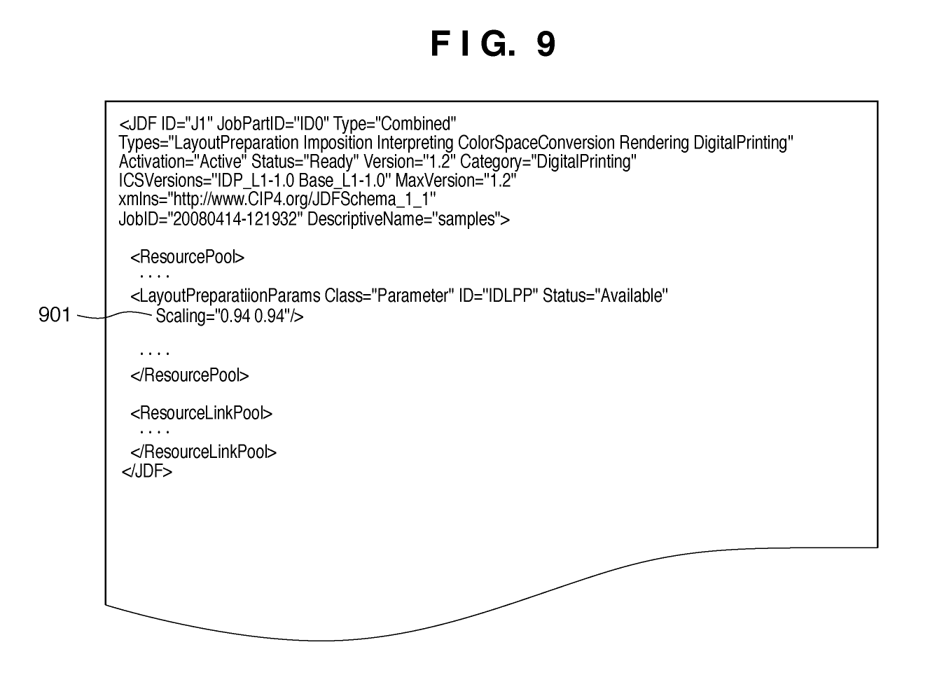

FIG. 9 depicts a view illustrating an example of a job ticket issued from the computer 101. A job ticket is shown for a case in which the image data shown in FIG. 8 is transmitted.

FIG. 9 shows an example in which JDF (Job Definition Format) has been used. JDF is commonly and widely used in the printing industry, for example. For this job ticket, a file is created in the format as shown based on content that has been set using a UI screen displayed by the printer driver of the computer 101, and the job ticket is delivered to the digital printing device 1000. In the description of the present embodiment, only a minimum of settings items in FIG. 9 are described, and the remaining items are omitted. Reference numeral 901 denotes a scaling setting. Here, when scaling has been set to “94%” in the UI screen (not shown) of the print driver, that “94%” scaling is indicated not as a percentage, but as a value “0.94” obtained by converting to an enlargement/reduction ratio where “1” indicates same size magnification.

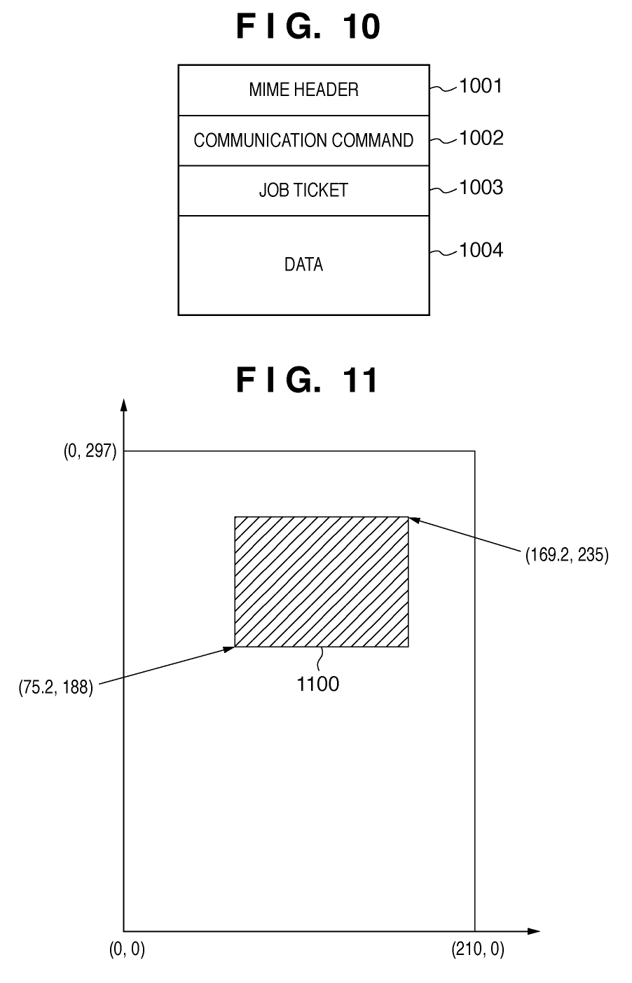

FIG. 10 depicts a view illustrating an example of the data configuration of a print job received by the digital printing device 1000 from the computer 101.

This print job is mainly composed of four parts. Data 1004 is produced after the print driver has performed conversion to a second data format, based on a first data format created by an application program of the computer 101. A job ticket 1003 corresponds to the job ticket in JDF format shown in FIG. 9. A communication command 1002 is obtained by converting various parameters used when distributing various statuses when executing the print job to a file format. The digital printing device 1000 according to the present embodiment has various workflow coordination functions for application in the POD marketplace. Thus, when a request to obtain status information from a device serving as an upstream workflow node or from a computer is received, a delivery command for that status information is described in the communication command 1002. A MIME header 1001 is header information to be produced when combining the above plurality of items of information, and converting them to a MIME format, such that the information can be transmitted as a single item of data. When a print job is transmitted to the digital printing device 1000 from the computer 101, job data that has been encoded in MIME format as shown in FIG. 10 is transmitted.

FIG. 11 depicts a view illustrating an example of results of the digital printing device 1000 receiving the job ticket shown in FIG. 9 and performing conversion processing.

Image data that has thus been converted is saved in the HDD 209. Here as well, the length of the image in the X direction is 210 mm, and the length of the image in the Y direction is 297 mm, so this image is the same size as the source image in FIG. 8, and not enlarged or reduced. On the other hand, the coordinates of the vertexes on a diagonal line of a rectangular rendered object 1100 included in this image are respectively (75.2, 188) and (169.2, 235). This reflects the results of the scaling designation. That is, because the scaling has been designated as “94%” in the print settings as described above, the digital printing device 1000 performed reduction processing based on the scaling setting when converting the image data.

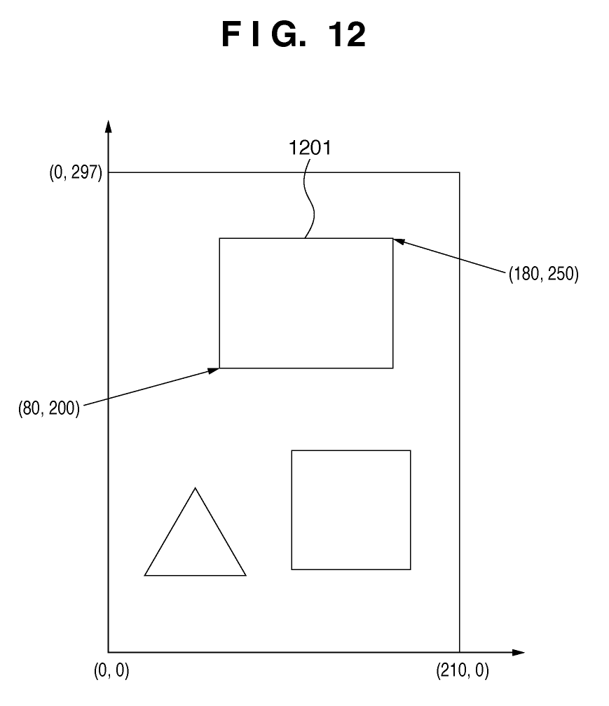

FIG. 12 depicts a view illustrating an example of second document data (an image) that has been created by an application program of the computer 101. However, the application used to create the second document data does not necessarily need to be the same application used when creating the document data (image) in FIG. 8 described above.

The size of this image is 210 mm in the X direction and 297 mm in the Y direction, and includes three rendered objects. Note that the rectangular area denoted by reference number 1201 is at the same coordinate position as the rectangular area in FIG. 8.

Next a case is considered in which, in a state in which the image data shown in FIG. 8 described above has been received and stored in the HDD 209, composition (overlay) of that image data with the image data in FIG. 12 has been instructed. More specifically, in this description, it is assumed that when printing the image data in FIG. 12 with the digital printing device 1000, printing is performed by adding clear toner to the rectangular area indicated by the image in FIG. 8. For example, this corresponds to a case such as in which image information such as a photograph has been arranged in the rectangular area 1201, and to that area, clear toner is applied in the rectangular area shown in FIG. 8 that is at the same coordinate position, thus producing glossy printed matter having high image quality.

Here, for the image shown in FIG. 12, a scaling setting such as for the image in FIG. 8 described above is not set, rather, printing at a default value of 100% has been instructed. Accordingly, the scaling attribute of the job ticket in this case is “1.00” at the scaling indicated by reference numeral 901 in FIG. 9, thus indicating equal magnification.

However, in the above example, scaling has been set to 94% as shown in FIG. 9, so as shown in FIG. 11, the coordinate position of the rectangular area differs from the coordinate position of the rectangular area 1201 in FIG. 12. Accordingly, if these images are overlaid in this state, the position of the rectangular area to be included in the printed matter will be offset when printed.

Thus, in the present embodiment, technology is described for obtaining printed matter in which image offset when compositing images due to using different scaling settings is eliminated.

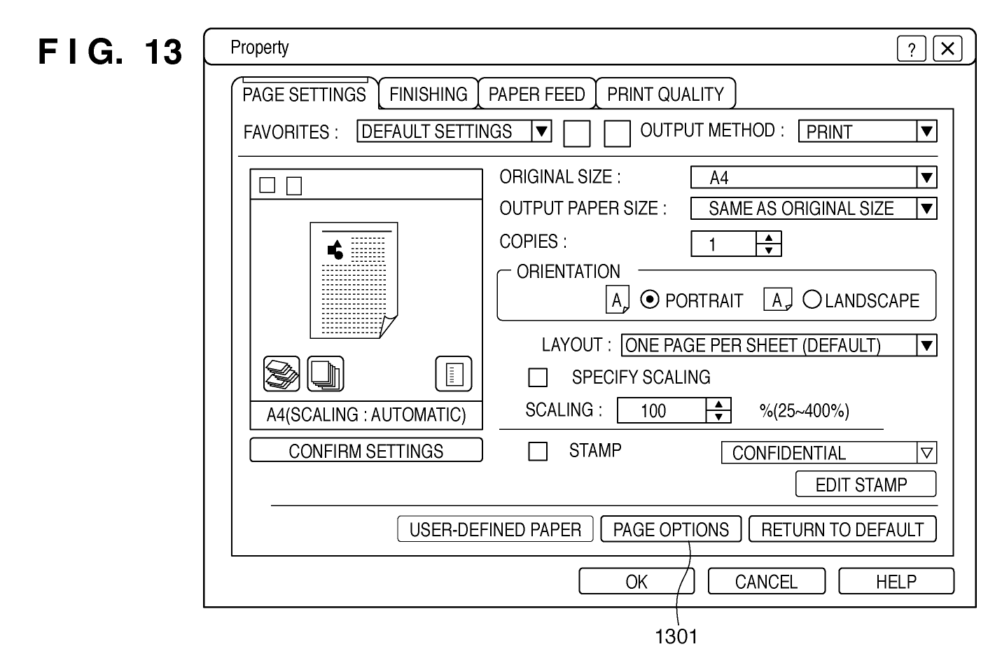

FIG. 13 depicts a view illustrating an example of a UI screen displayed in the display unit 310 by the printer driver of the computer 101 according to this embodiment. Here, it is possible to display a screen showing details of image composition processing by instructing a page option 1301.

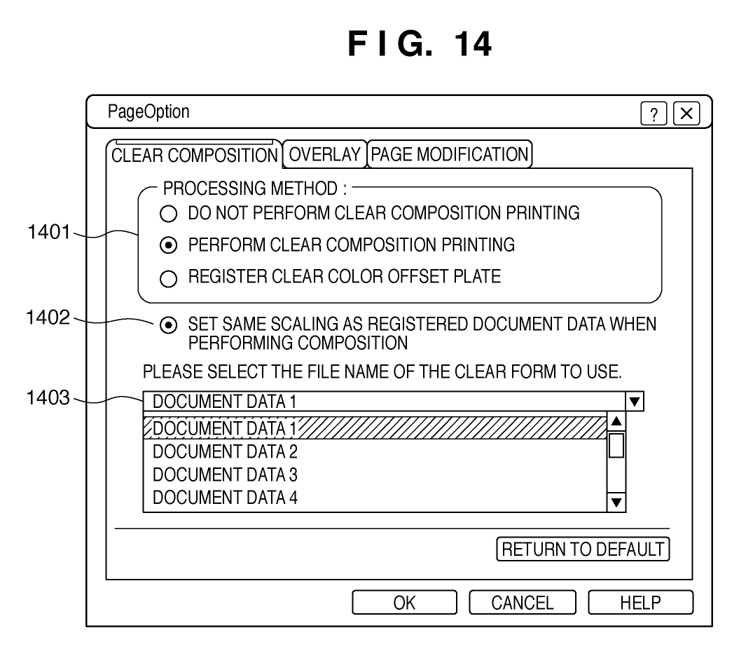

FIG. 14 depicts a view illustrating an example of a UI screen displayed in the display unit 310 when a page option 1301 has been instructed. In the present embodiment, clear composition, overlay, page modification, and so forth can be set as a page option, but FIG. 14 shows an example in which a clear composition function has been selected. Switching of page option functions is performed by selecting a tab in the upper part of a screen.

“Processing method” 1401 is an item for performing main settings related to a clear printing function, and can be used to select any one of “do not perform clear composition printing”, “perform clear composition printing”, and “register clear color offset plate”. In FIG. 14, “perform clear composition printing” has been selected. “Register clear color offset plate” is selected in order to execute processing to register image data to be composited in the digital printing device 1000. Reference numeral 1403 denotes a screen for selecting a clear color offset plate to be composited when “perform clear composition printing” has been selected in the item “processing method” 1401. A list of image data present in the selection screen can be displayed by the computer 101 obtaining information of the document management table 601 to be stored in the HDD 209 of the digital printing device 1000 shown in FIG. 7. In FIG. 14, an item “document data 1” has been selected. The item “document data 1” is the aforementioned image data that has been reduced to 94%, shown in FIG. 11. A radio button 1402 is a button for selecting whether or not to set the same scaling for image data to undergo composition, to be overlaid with a clear color offset plate, as the scaling for image data of the clear color offset plate. That is, this button is for selecting whether or not to set the same scaling when printing print data for which the composition print processing is attempted to be executed in this screen as the scaling for the clear offset plate (the document data 1 that has been selected with item 1403) being held in the digital printing device 1000. When the radio button 1402 is checked, scaling of the image data to be overlaid is set based on the scaling setting of the job ticket being managed by the document management table 601 of the HDD 209 of the digital printing device 1000.

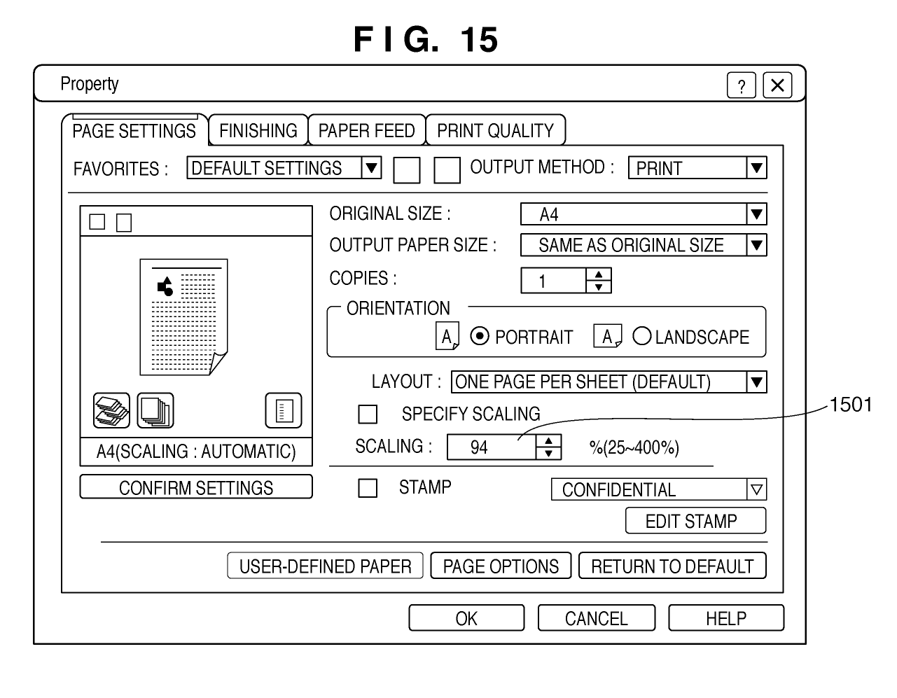

FIG. 15 depicts a view illustrating an example of a UI screen displayed when an “OK” button has been instructed in FIG. 14.

Here, because the radio button 1402 in FIG. 14 has been checked, “94%”, which is the same scaling as the image in FIG. 8 described above, has been set in a scaling setting unit 1501 that designates scaling. Thus, composition of the rendered object 1100 shown in FIG. 11 and the rectangular area 1201 shown in FIG. 12 will be performed, without position offset.

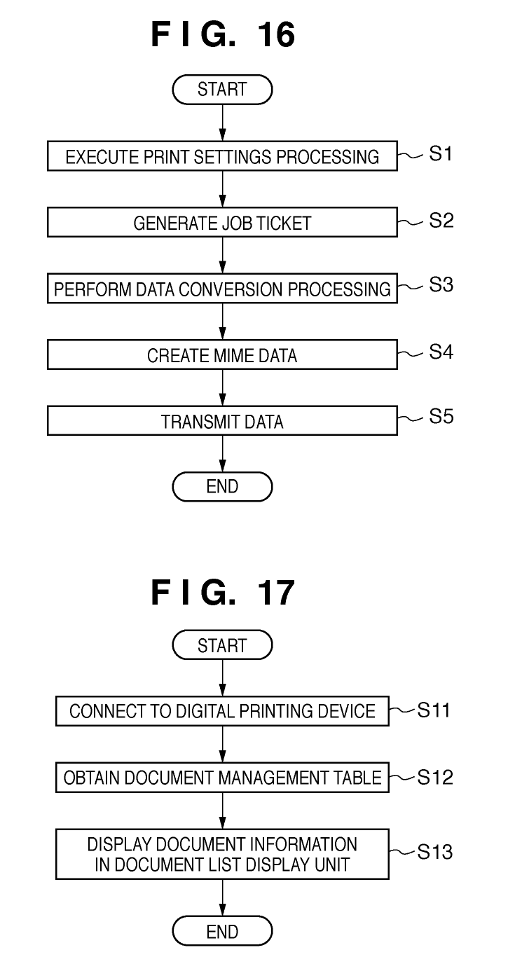

FIG. 16 is a flowchart describing print processing executed by an application that operates in the computer 101 according to the present embodiment. Here, the term print processing also encompasses saving processing to store a document in the HDD 209 of the digital printing device 1000, which does not actually involve printing. A program for executing this processing is stored in the ROM 303 at the time of execution, and is executed under control by the CPU 301.

This processing is started due to selection of a print function by an application program. First, in step S1, print settings processing is executed. Specifically, this step S1 is realized by the user performing processing for various print settings using a UI screen displayed by the print driver. The print settings items in step S1 include processing to select all settings items. Settings related to the clear composition function according to the present embodiment, settings related to processing to save documents in the HDD 209 of the digital printing device 1000, and so forth are also included in the processing in step S1. Once such print settings are completed, processing advances to step S2, where a job ticket is created according to the settings items that have been set in step S1. Specifically, a job ticket as shown in FIG. 9 is created according to the settings items that were selected by the user in step S1. Next, processing advances to step S3, where conversion processing of image data to be printed is executed. Specifically, data that has been created by an application program is converted from a data format inherent to that application to a data format that can be interpreted by the digital printing device 1000. This conversion processing in step S3 is executed by the print driver. Thus, by the processing in steps S1 to S3, information necessary for transmission of a print job has been prepared. Next, processing advances to step S4, where the job ticket and image data that have been created in steps S2 and S3 are converted to data in the MIME format shown in FIG. 10. Then processing advances to step S5, where the MIME format data obtained in step S4 is transmitted to the digital printing device 1000, and once transmission is completed this processing is ended.

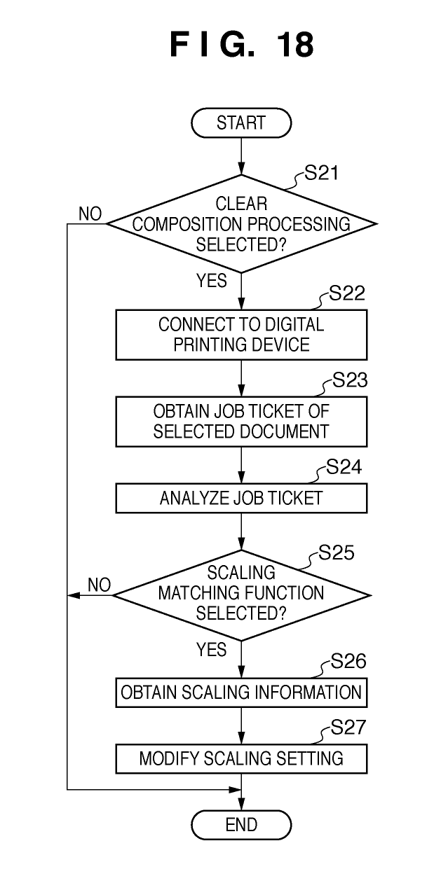

FIG. 17 is a flowchart describing processing related to information obtaining processing of document data to be composited when performing setting processing for clear composition printing in the print settings processing executed in step S1 of FIG. 16. This processing instructs the page option 1301 in FIG. 13, thus displaying the settings screen in FIG. 14, and furthermore is started at the stage when the print instruction “perform clear composition printing” has been selected with the item “processing method” 1401.

First, in step S11, processing for obtaining information of the documents that have been displayed in the document list 1403 in FIG. 14 is executed. Specifically, in step S11, processing is performed to connect to the digital printing device 1000 in order to obtain information. Once the connection of the computer 101 to the digital printing device 1000 is established, processing proceeds to step S12, where the information in the document management table 601 shown in FIG. 7 is obtained. This document management table 601 is being stored in the HDD 209 of the digital printing device 1000.

Next, processing proceeds to step S13, where based on the information of the document management table 601 that was obtained in step S12, document names that are registered in the document management table 601 are displayed in the document list 1403 in the screen in FIG. 14, for example. Thus, the user can select document data to be composited.

FIG. 18 is a flowchart describing processing of the computer 101 to be executed when the “OK” button in FIG. 14 has been instructed in a state in which the radio button 1402 in FIG. 14 has been checked. A program that executes this processing is stored in the RAM 302 at the time of execution and is executed under control by the CPU 301.

First, in step S21, a determination is made of whether or not “perform clear composition printing” has been selected as the processing method in the settings screen shown in FIG. 14. If the result of this determination is false (NO), then it is not necessary to modify the setting of the scaling value, and so this processing is ended. On the other hand, if the result of the determination in step S21 is true (YES), then processing proceeds to step S22. In step S22, a connection with the digital printing device 1000 is established. Note that the processing in step S22 is not necessary if a connection has already been established with the digital printing device 1000. Then processing proceeds to step S23, where a job ticket of the document that has been selected in the document list 1403 in the settings screen shown in FIG. 14 is obtained. Specifically, based on the information in the document management table 601 that was obtained in the flowchart in FIG. 17, the job ticket file of the document selected in FIG. 14 is obtained from the HDD 209 of the digital printing device 1000. Next, processing advances to step S24, where processing is performed to analyze the job ticket obtained in step S23. There are various results of this analysis and information to be obtained, but the description here is limited to the scaling setting item related to the present embodiment.

Next, processing proceeds to step S25, where a determination is made of whether or not the radio button 1402 in FIG. 14 is checked. When determined that the radio button 1402 is checked, processing proceeds to step S26, where among the job ticket information that was analyzed in step S24, the setting value of the scaling setting item is obtained. Next, processing proceeds to step S27, where the CPU 301 determines whether or not the scaling setting value that was obtained in step S26 is the same as the scaling setting value that was analyzed in step S24. According to that determination, the CPU 301 determines whether or not an image to be printed to a sheet matches image data to undergo composition, based on the image data to be composited. When the scaling setting value that was obtained in step S26 is the same as the scaling setting value that was analyzed in step S24, the CPU 301 proceeds without performing the processing in step S27. On the other hand, when determined that the scaling setting value that was obtained in step S26 is not the same as the scaling setting value that was analyzed in step S24, the processing in step S27 is performed. In step S27, the CPU 301 reflects the scaling value obtained in step S26 in the print settings item. That is, at this stage the scaling of the image to undergo composition is the same as the scaling of the document data that is being held in the digital printing device 1000 and is to be composited (overlaid). On the other hand, if the result of the determination in step S25 is false (NO), processing to coordinate the scaling of the document data to be composited is not necessary, so this processing is ended.

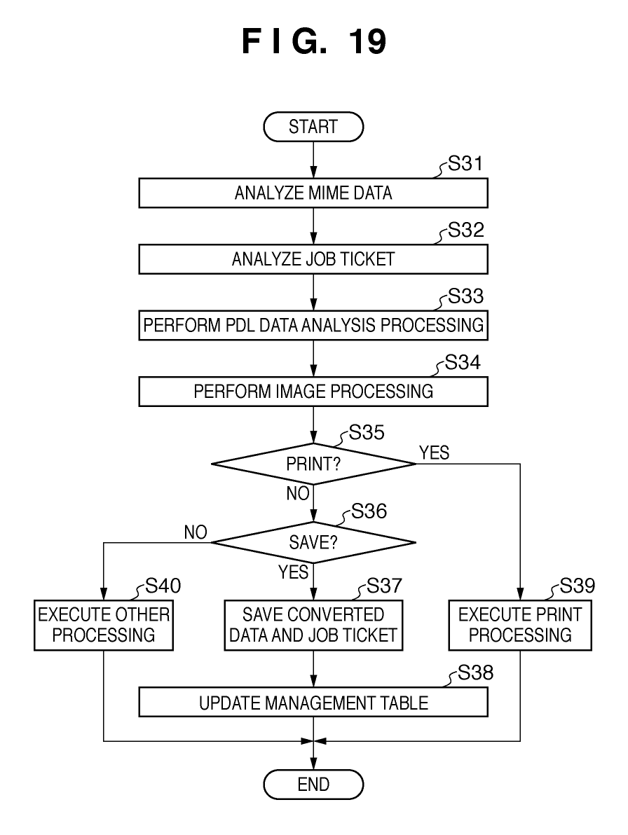

FIG. 19 is a flowchart describing print processing executed when the digital printing device 1000 according to the present embodiment has received a print job from the computer 101. A program that executes this processing is stored in the ROM 207 at the time of execution and is executed under control by the controller (CPU) 205.

This processing is started due to the controller 205 detecting receipt of print job data by the external I/F unit 202, and first in step S31, the controller 205 analyzes received MIME data. Here, the MIME data to be analyzed is in the format described above with reference to FIG. 10. The content of this analysis processing also includes processing to extract a plurality of items of data included in the MIME data, and temporarily save them in the HDD 209 or the RAM 208, for example. Next processing proceeds to step S32, where processing to analyze job ticket parts included in the MIME data analyzed in step S31 is executed. Next processing proceeds to step S33, where processing is executed to analyze the data parts analyzed in step S31, based on the result of job ticket analysis in step S32. The data of the data parts ordinarily is PDL data, and image data to be printed is most often created according to the analysis in step S33. Next processing proceeds to step S34, where remaining processing not completed in step S33 is executed. In the present embodiment, image composition processing corresponds to this processing, but in the description of the flowcharts this is more broadly referred to as image processing. By completion of the processing up to step S34, data in a format that is printable by the print unit 203 is obtained.

In step S35, the processing content of the job received from the computer 101 is discriminated, and a determination is made of whether or not any of processing to perform printing, saving, or other processing has been designated. More specifically, processing is executed to discriminate the item that has been designated with “output method” in the UI screen of the print driver of the computer 101. This determination processing is determined based on the settings items described in the job ticket that was analyzed in step S32 to obtain a result. When printing is determined in step S35, processing proceeds to step S39, where print processing is executed. On the other hand, when determined in step S35 that print processing has not been designated, processing proceeds to step S36, where a determination is made of whether or not “save” has been designated. In step S36, when “save” has been designated, processing proceeds to step S37, where image data and the job ticket obtained in the processing in steps S31 to S34 are saved in the HDD 209. Then processing proceeds to step S38, where the management table is updated according to the information regarding the document data and job ticket that were newly saved in the HDD 209 in step S37. On the other hand, when determined in step S36 that “save” has not been designated, this corresponds to a state in which neither “save” or “print” has been selected as the processing content selected from the selection menu in the UI screen. The processing content in this case is not essential to the description of the present embodiment, so in this description, next processing advances to step S40, where it is merely stated that other processing is executed.

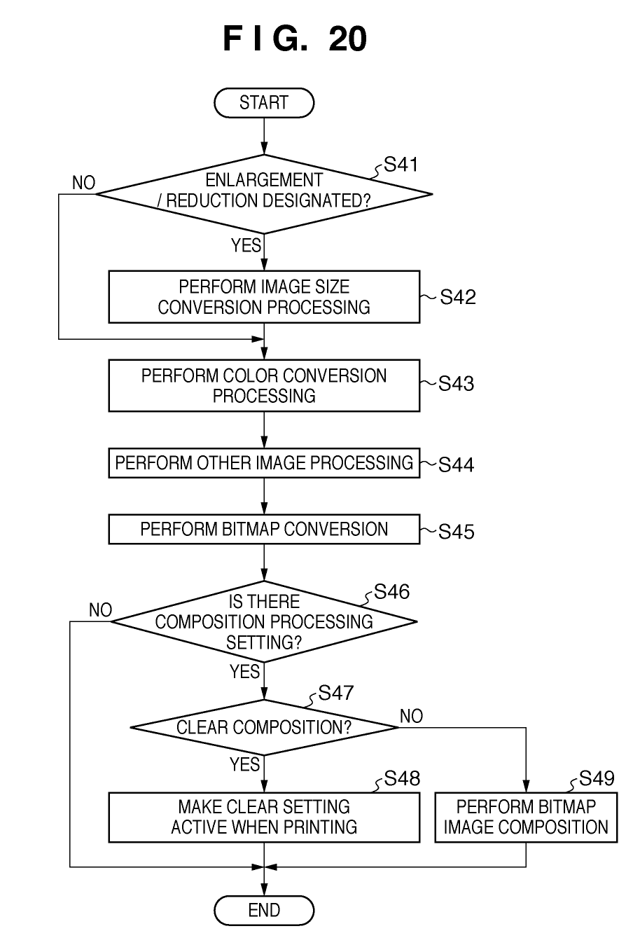

FIG. 20 is a flowchart describing details of image processing executed by the digital printing device 1000 in step S34 of FIG. 19.

First, in step S41, a determination is made of whether or not there exists a selection of processing to perform image enlargement or reduction in the received job ticket. When the result of this determination is true (YES), processing proceeds to step S42, where size conversion processing is executed according to the enlargement/reduction of the image, and then the process proceeds to step S43. On the other hand, when the result of this determination in step S41 is false (NO), processing skips step S42 and proceeds to step S43. In step S43, color conversion processing is performed. Then processing proceeds to step S44, where other image processing is executed. The specific content of the processing performed in these steps S43 and S44 is not important for describing the effects of this embodiment of the present invention and therefore is omitted from the description. Thus, at the stage of completion of processing up to step S44, image processing to be performed for the print job received by the digital printing device 1000 is basically concluded. Then processing advances to step S45, where based on image information to be produced as a result of image processing, conversion to a bitmap image is performed. This step is performed because conversion to a format that can be printed by the print unit 203 is necessary.

Next processing proceeds to step S46, where a determination is made of whether or not a setting related to composition processing is included in the job ticket of the received print job. When a determination is made in step S46 that a setting related to composition processing is included, processing proceeds to step S47, where a determination is made of whether or not that composition processing is clear composition processing. When a determination is made in step S47 that clear composition processing has been set, processing proceeds to step S48, where when printing, composition of a clear color offset plate is performed and the settings for performing print processing are made active. On the other hand, when the determination result in step S47 is false (NO), processing proceeds to step S49, where ordinary image composition processing is performed. That is, bitmap composition processing of the image to be composited and the image to undergo composition is performed. When determined in step S46 that composition processing is not set, this image processing routine is ended without performing processing related to composition.

Here, regarding composition processing, the reasons that it is necessary to determine whether the image composition processing is clear composition processing or some other form of image composition processing in step S47 will be further supplemented. With image composition that is not clear composition, the pixels of the image to be composited and the image to undergo composition are merged, and by overlaying CMYK plates and printing in the print unit 203 it is possible to obtain desired printed matter. On the other hand, in the case of clear composition, transparent toner based on a fifth plate that is not any of CMYK is printed to paper on which CMYK printing has been performed. That is, because clear composition corresponds not to bitmap composition, but to overlay composition processing when printing, so the composition print processing performed in the print unit 203 is fundamentally different.

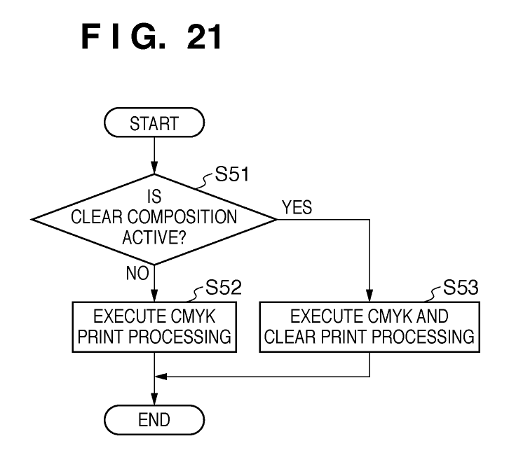

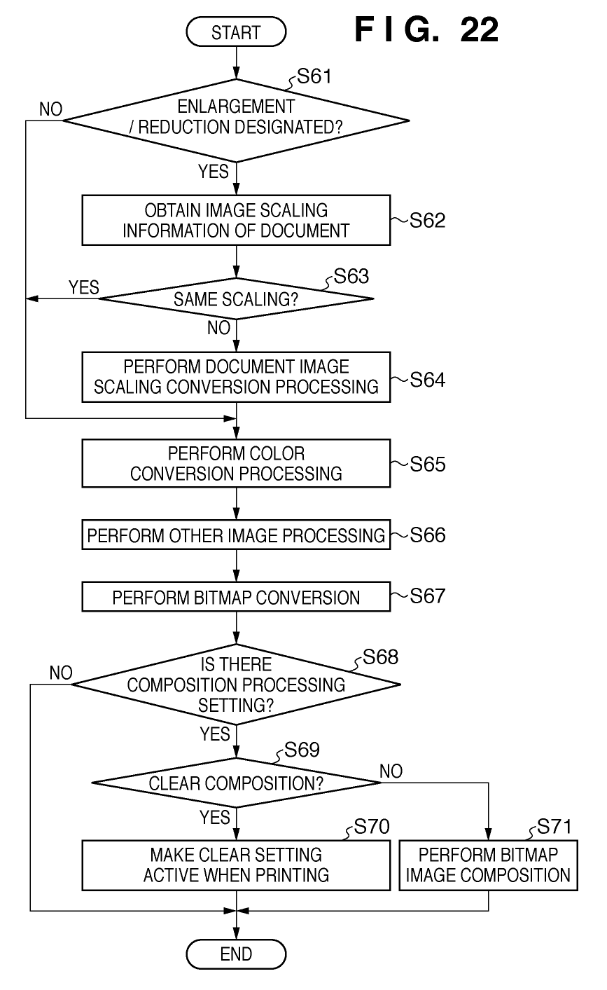

FIG. 21 is a flowchart describing print processing executed by the digital printing device 1000 in step S39 of FIG. 19.

First, in step S51, a determination is made of whether or not clear composition has become active in the print job. This determination processing is the processing in step S47 in FIG. 20. Here, when clear composition has not been set, processing proceeds to step S52, where print processing is executed not using clear composition, but using ordinary CMYK plates. On the other hand, when clear composition has been instructed in step S51, processing proceeds to step S53, where print processing is executed using a clear color offset plate in addition to ordinary CMYK plates.

As described above, according to the first embodiment, when performing image composition processing using a composition function of a digital printing device, it is possible to prevent misregistration of the result of composition of an image to be composited and an image to undergo composition. As described above, misregistration is a phenomenon whereby the positions or areas of the images that are overlaid are offset from each other by a predetermined amount, and thus there is a decrease in quality of the image obtained by compositing and then printed. Also, the operator can easily set settings for preventing such misregistration using the button 1402 shown in FIG. 14, for example.

### Second Embodiment

In the above first embodiment, an example is described in which the digital printing device 1000 performs processing to adjust the scaling of the image to undergo composition relative to the image to be composited. However, a configuration may also be adopted in which scaling modification processing for matching the scalings to prevent misregistration when printing is performed by the computer 101.

Specifically, a configuration is acceptable in which when performing the data conversion processing in step S3 in FIG. 16, that is, when producing PDL data, data conversion processing is executed in consideration of the scaling setting that was modified in step S27 in FIG. 18.

Also, the above first embodiment describes modifying the scaling of the image to undergo composition, which will be composited with the clear color offset plate. A configuration may also be adopted in which, for example, scaling is modified for the image data of the image to be composited, that is, the clear color offset plate that has been stored in the HDD 209.

FIG. 22 is a flowchart describing processing that accompanies a modification in scaling of the image to be composited in step S34 of FIG. 19, executed by the digital printing device 1000. A program that executes this processing is stored in the ROM 207 at the time of execution and is executed under control by the controller (CPU) 205.

First, in step S61, a determination is made of whether or not there exists a selection of processing to perform image enlargement or reduction in the received job ticket. When the result of this determination is true, processing proceeds to step S62, where the scaling setting value described in the job ticket of the document data to be composited is obtained. Next processing proceeds to step S63, where a determination is made of whether or not the scaling value obtained in step S62 differs from the scaling value included in the job ticket of the received job. Thus, the controller 205 determines whether or not an image area of the image to be printed to a sheet based on the image data to be composited matches an image area of the image data to undergo composition. When the scalings match, the controller 205 determines that the area of the image to be printed to a sheet based on the image data to be composited matches the image area of the image data to undergo composition. When the scalings do not match, the controller 205 determines that the area of the image to be printed to a sheet based on the image data to be composited does not match the image area of the image data to undergo composition. When the scalings match in step S63, processing proceeds to step S65, and when the scalings differ, processing proceeds to step S64, where the scaling of the image to undergo composition, that is, the image of the document data to be held in the HDD 209, is set to the same scaling as the job ticket. When assuming that ordinary scaling modification will be performed, a scalable representational data format is used as the format of the image data on which the scaling modification processing executed in step S64 is to be performed. Such a data format is used in order to suppress the occurrence of worsened image quality, such as jagged lines, in the image produced after performing the scaling modification. However, processing to modify the scaling is possible even in the case of image data that has been converted to bitmap image data, although this will result in some amount of image deterioration. Therefore, a scalable bitmap format or other scalable data format may be used as the format of the image data on which the scaling modification processing executed in step S64 is to be performed. When there is not an enlargement or reduction designation in step S61, or when determined that the scalings are the same in step S63, processing proceeds to step S65.

In step S65, color conversion processing is performed. Then processing proceeds to step S66, where other image processing is executed. The specific content of the processing performed in steps S65 and S66 is not important for describing the effects of this embodiment of the present invention and therefore is omitted from the description. At the stage of completion of processing up to step S64, image processing to be performed for the print job received by the digital printing device 1000 is basically concluded. Then processing advances to step S67, where based on image information to be produced as a result of the image processing in steps S65 and S66, conversion to a bitmap image is performed. This step is performed because conversion to a format that can be printed by the print unit 203 is necessary. Next processing proceeds to step S68, where a determination is made of whether or not a setting related to composition processing is included in the job ticket of the received print job. When composition print processing has been designated, processing proceeds to step S69, where a determination is made of whether or not clear composition printing has been instructed. When clear composition printing has been instructed, processing proceeds to step S70, where composition of a clear color offset plate is performed and the internal settings for performing processing are made active. On the other hand, when clear composition printing has not been instructed in step S69, processing proceeds to step S71, where bitmap composition processing of the image to be composited and the image to undergo composition is performed. When determined in step S68 that image composition processing has not been designated, this processing routine is ended without performing processing related to composition. The reasons that it is necessary to determine whether or not the image composition processing is clear composition processing or some other form of image composition processing in step S69 are as described with reference to FIG. 20.

Note that in step S64, the scaling of the image to undergo composition is matched to the image data of the received print job, but the present invention is not limited to this, a configuration may also be adopted in which the image data of the received print job is matched to the scaling of the image to undergo composition.

### Third Embodiment

In the above embodiments, when the scaling of the image to be composited is not the same as the scaling of the image to undergo composition, this fact is detected, and correction is performed such that those scalings become the same. In the third embodiment, although detection of whether or not those scalings are the same is performed, correction processing is not performed.

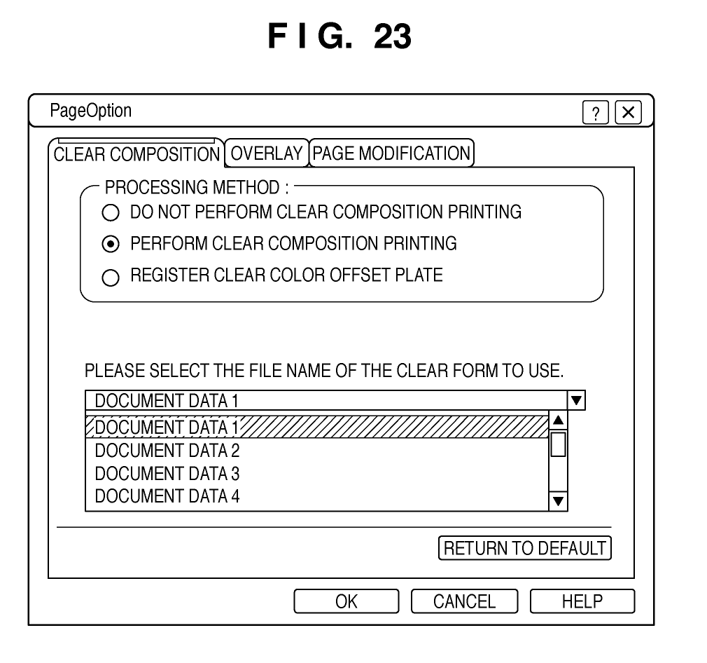

FIG. 23 depicts a view illustrating an example of a screen that corresponds to FIG. 14 according to the above first embodiment. This screen differs from the screen in FIG. 14 in that here, there is no radio button 1402 for automatic setting of scaling when scaling is not the same.

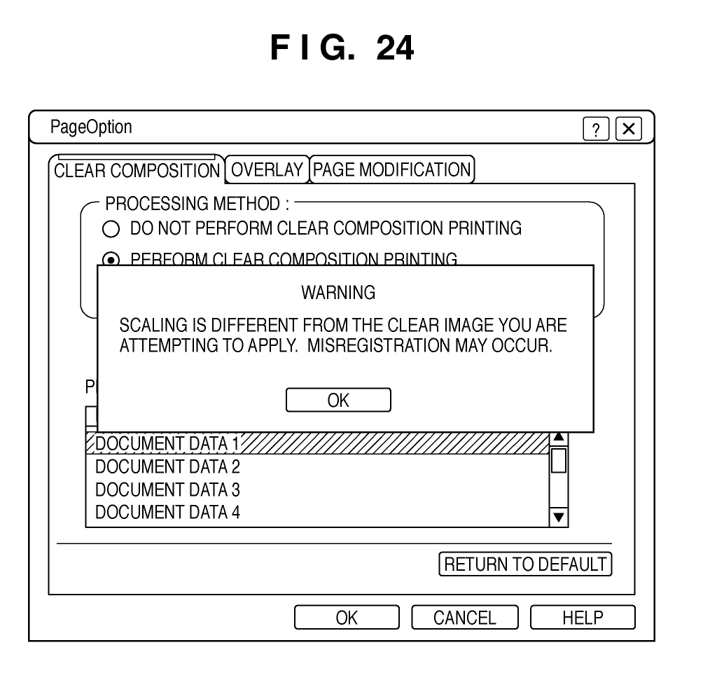

FIG. 24 depicts a view illustrating an example of a screen displayed immediately after identifying that the scaling of the image to be composited and the scaling of the image to undergo composition are not the same, when clear image data to be composited has been selected in the screen shown in FIG. 23.

Here, because the scalings are not the same, the user is warned of the possibility that misregistration will occur. As in the previous embodiments, although there are users for which it is recognized to be more convenient to have automatic correction of scaling as a function, there are also users for which when the user's intended scaling is not known, production of scaling-matched printed matter is a concern. That is, the system detects whether or not the scalings match, and thereafter, it is possible to select whether to again produce an image to be composited, or possible to perform confirmation and then readjust the scaling of the image to undergo composition and continue the job. Thus, there is a wider range in which it is possible to perform control so as to produce printed matter as the user intends. In this third embodiment, processing to automatically correct scaling is not performed, in consideration of the convenience of an operator possessing greater skill.

Note that in the first to third embodiments, an example is described in which there is a mismatch of images based on different scaling, but the present invention is not limited to this. That is, a case is also conceivable in which a mismatch of images is caused by minute differences in image object arrangement (image position (shift setting)) due to using different applications when creating the respective items of image data, for example. Alternatively, a case is also conceivable in which a mismatch of images is caused by differences in the origin point coordinates of the driver/RIP processing system, or default scaling (or scaling adjustment value). Alternatively, a case is also conceivable in which a mismatch of images is caused by differences in the default values (scaling, margin amount, origin point position, origin point coordinates) for each application. Accordingly, in any of these cases as well, it is possible to eliminate a mismatch of images by modifying the corresponding processing parameters.

As described above, according to the first to third embodiments, it is possible to easily realize image composition processing employing a composition function of a digital printing device. Also, it is possible to reduce the workload on an operator when performing clear printing or the like. Furthermore, it is possible to easily deal with a case in which a different application is used to create an image to be composited, and so the positions or sizes of respective images differ. Also, along with greatly improving the convenience of the image composition function sought for digital printing devices aimed at the POD marketplace, it is possible to obtain a composite image having no image position offset.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-216167, filed Sep. 17, 2009, which is hereby incorporated by reference herein in its entirety.

What is claimed is:

1. A print apparatus for receiving image data from an external device and executing printing based on the received image data, the apparatus comprising:
a receiving unit that receives first image data;
a storage unit that stores second image data to be combined with the first image data received by the receiving unit;
a determination unit that determines whether or not an image area of the first image data and an image area of the second image data match if the second image data of the storage unit is overlaid with the first image data;
a modification unit that modifies any one of the first image data and the second image data when the determination unit determines that the image area of the first image data and the image area of the second image data do not match; and
a print unit that performs printing by overlaying the one of the first image data and the second image data that has been modified by the modification unit and the other image data that has not been modified by the modification unit.

2. The print apparatus according to claim 1, wherein the determination unit performs determination based on whether or not a scaling that has been set for the first image data is the same as the scaling that has been set for the second image data.

3. The print apparatus according to claim 1, wherein the determination unit performs determination based on whether or not an image position of the first image data is the same as the image position of the second image data.

4. The print apparatus according to claim 1, wherein the determination unit performs determination based on whether or not origin point coordinates of the first image data are the same as the origin point coordinates of the second image data.

5. A print control apparatus for transmitting image data to a print apparatus, the print control apparatus comprising:
an accepting unit that accepts a composite instruction for overlaying first image data and second image data being stored in the print apparatus;
an obtaining unit that, when the composite instruction has been accepted, obtains a processing parameter that has been set for the second image data;
a determination unit that determines whether or not an image area of the first image data and an image area of the second image data match if the first image data and the second image data are overlaid, based on the processing parameter;
a modification unit that modifies the first image data when the determination unit has determined that the image area of the first image data and the image area of the second image data do not match; and
a transmitting unit that transmits the first image data that has been modified by the modification unit to the print apparatus.

6. The print control apparatus according to claim 5, wherein the second image data is stored in the print apparatus, and the obtaining unit obtains the processing parameter from the print apparatus.

7. The print control apparatus according to claim 5, wherein the processing parameter is a scaling that has been set for the second image data.

8. The print control apparatus according to claim 5, wherein the processing parameter is an image position that has been set for the second image data.

9. The print control apparatus according to claim 5, wherein the processing parameter is origin point coordinates of the second image data that have been set for the second image data.

10. An image processing apparatus, comprising:
an input unit that inputs first image data;
a storage unit that stores second image data to be overlaid with the first image data that has been input by the input unit;
a modification unit that, based on a scaling that has been set for the second image data that has been stored in the storage unit and the scaling that has been set for the first image data that has been input by the input unit, modifies any one of the first image data and the second image data; and
an overlay unit that overlays the one of the first image data and the second image data that has been modified by the modification unit and the other image data that has not been modified by the modification unit.
